(19) United States
(12) Patent Application Publication
(10) Pub. No.: US 2015/0051962 A1
(43) Pub. Date: Feb. 19, 2015

(54) SYSTEMS AND METHODS FOR MANAGING SOCIAL NETWORKS FOR COUPON DISTRIBUTION

(71) Applicants: Nimrod SANDLERMAN, Ramat-Gan (IL); Amir HERMONI, Yavne (IL)

(72) Inventors: Nimrod Sandlerman, Ramat-Gan (IL); Amir Hermoni, Yavne (IL)

(21) Appl. No.: 14/386,805

(22) PCT Filed: Mar. 21, 2013
(86) PCT No.: PCT/IB2013/052241

§ 371 Date: Sep. 21, 2014

Related U.S. Application Data
(60) Provisional application No. 61/614,324, filed on Mar. 22, 2012.

(51) Int. Cl. G06Q 30/02

(52) U.S. Cl. CPC G06Q 30/0222
USPC 705/14.23

(57) ABSTRACT

A method and a system for distributing coupons for buying articles enabling a first user to provide a second user with an entitlement to a coupon, enabling the second user to obtain the coupon providing a price reduction for buying an article, and, upon the purchase of the article using the coupon, providing a commission to the first user.

### CROSS-REFERENCE TO RELATED APPLICATIONS

This application claims the priority benefit of U.S. Provisional Patent Application No. 61/614324 filed Mar. 22, 2012, which is incorporated herein by reference.

### FIELD OF THE INVENTION

The present invention generally relates to systems and methods for developing, managing and operating social networks for distributing coupons, and, more particularly, but not exclusively, to methods and systems for distributing coupon commissions among the members of the social networks.

### BACKGROUND OF THE INVENTION

The use of coupons as a marketing tool is well known. Coupons usually bear some kind of price reduction that a user presenting the coupon may receive when purchasing the article for which the coupon is issued. Coupons are usually distributed by the vendor to the user via dedicated coupon distribution channels. There are many types of web sites operating as coupon distribution channels. Web sites require the user initiative to access the web site, retrieve the coupon and then use it.

Coupon distribution by mail, in physical (printed matters) or electronic media, is also known. Mailed messages, and especially email messages, are prone to be treated as junk mail or spam.

Multi level marketing (MLM) is a well known method too. Generally speaking, MLM uses the buyers as sellers instead of the common chain of distributors, wholesalers, and retailers. However, the cost of establishing an effective MLM network is prohibitive for most articles.

There is thus a recognized need for, and it would be highly advantageous to have, a method and a system for distributing coupons that overcomes the abovementioned deficiencies.

### SUMMARY OF THE INVENTION

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may vary without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

According to one aspect of the present invention there is provided a method for distributing coupons for buying articles, the method including the steps of: enabling a first user to provide a second user with an entitlement to a coupon, enabling the second user to obtain a coupon, where the coupon includes a price reduction for buying an article, and a commission, and upon a purchase of the article using the coupon, providing the first user the commission.

According to another aspect of the present invention there is provided the method for distributing coupons for buying articles additionally including identification means for uniquely identifying the coupon and/or the entitlement, and/or the first user and/or the second user.

According to still another aspect of the present invention there is provided the method for distributing coupons for buying articles where the first user includes a plurality of users and the commission is distributed among the plurality of users.

According to yet another aspect of the present invention there is provided the method for distributing coupons for buying articles where the plurality of users includes a chain of users providing entitlements.

Further according to another aspect of the present invention there is provided the method for distributing coupons for buying articles additionally including a step of using said identification means for identifying users within said chain of users, and/or the order of the users in the chain of users, and/or the position of a user in the chain of users.

Yet further according to another aspect of the present invention there is provided the method for distributing coupons for buying articles where the commission is distributed among the plurality of users according to the user's position in the chain. The method of claim 1 wherein said first user comprises a sequence of users providing entitlements from one user to another, and, upon a purchase of said article by said second user using said coupon, distributing said commission to users of said sequence of users according to said user's position in said sequence of users.

Still further according to another aspect of the present invention there is provided the method for distributing coupons for buying articles where the first user includes a tree of users providing entitlements from one user to another starting with a root user and branching thereof, said method additionally including the steps of: using the identification means for identifying a chain of users leading from the second user to the root user, and distributing the commission to users of the chain of users according to the user's position in the chain.

Even further according to another aspect of the present invention there is provided the method for distributing coupons for buying articles where said first user includes a tree of users providing entitlements from one user to another and where the method additionally includes the steps of: registering a user receiving an entitlement as a subordinate of a user sending the entitlement, identifying a chain of subordinates leading to the second user, and distributing the commission to users of the chain of users according to the user's position in said chain.

Yet according to another aspect of the present invention there is provided a method for selling a plurality of articles, the method including the steps of: providing a server computing device operative to communicate with a plurality of client computing devices; providing a distribution management software program for being executed by the server computing device; using the distribution management software program, setting a base price for an article of the plurality of articles, using the distribution management software program, setting a coupon price, the coupon entitling a buyer to buy an article using the method; using the distribution management software program, setting a coupon refund value; where the distribution management software program enabling a buyer using the client computing device to buy at least one of the articles and at least one of the coupons, at the base price plus the coupon price multiplied by a number of coupons bought with each of the articles; and where the distribution management software program refunding the buyer the coupon refund value for each coupon sold to the buyer and thereafter used for buying an article using a client computing device communicating with the server computing device.

Additionally, according to another aspect of the present invention there is provided a method for selling a plurality of articles where the step of enabling a buyer to buy at least one of the articles is limited to a buyer presenting a coupon.

According to yet another aspect of the present invention there is provided a method for selling a plurality of articles where the step of enabling a buyer to buy at least one of the articles is limited to a buyer using the client computing device communicating with the server computing device.

According to still another aspect of the present invention there is provided a method for selling a plurality of articles where the step of refunding a buyer is limited to a coupon used for buying an article by a buyer other than the buyer who bought the coupon.

Yet according to another aspect of the present invention there is provided a method for selling a plurality of articles where the buyer presenting a coupon is not the buyer who bought the coupon.

Still according to another aspect of the present invention there is provided a method for selling a plurality of articles additionally including the step of setting a number of coupons sold to a buyer with each article sold to the buyer, where this step is executed using the distribution management software program.

Further according to another aspect of the present invention there is provided a method for selling a plurality of articles additionally including the step of enabling a buyer using the client computing device communicating with the server computing device to set number of coupons sold to the buyer.

Further according to yet another aspect of the present invention there is provided a method for selling a plurality of articles, where a deal price is a sum of number of articles sold to a buyer multiplied by the base price, plus number coupons sold to the buyer multiplied by the coupon price, minus the refund value multiplied by the number coupons sold to the buyer, is positive.

Further according to still another aspect of the present invention there is provided a method for selling a plurality of articles additionally including the steps of: setting at least one of: a number of articles for sale, and a number of coupons for sale; and, if user presents a coupon for buying an article, and if all coupons for sale are sold, the article being offered to the user at a price not higher than the base price and not lower than the deal price.

According to yet another aspect of the present invention there is provided a computing device connected to a public communication network and enabling a user operating a client computing device to participate in a program for distributing articles, where the participation involves at least one of the actions of: initiating the program; buying an article and at least one coupon; and distributing a coupon; where the program includes the steps of: setting a base price for an article of the plurality of articles, setting a coupon price, the coupon entitling a buyer to buy an article using the method; setting a coupon refund value; selling to a buyer at least one of the articles and at least one of the coupons, at the base price plus the coupon price multiplied by a number of coupons sold with each of the articles; and refunding the buyer the coupon refund value for each coupon sold to the buyer and used by a buyer for buying the article; where the buyer is entitled to distribute the at least one coupon, and where the coupon entitles a buyer using the client computing device communicating with the server computing device to buy at least one of the articles and at least one of the coupons.

According to still another aspect of the present invention there is provided a method of operating a server computing device, the computing device connected to a public communication network and enabling a user operating a client computing device to participate in a program for distributing articles, where the participation involves at least one of the actions of: initiating the program; buying an article and at least one coupon; and distributing a coupon; where the program includes the steps of: in the computing device, setting a base price for an article of the plurality of articles, using the computing device, setting a coupon price, the coupon entitling a buyer to buy an article using the method; using the computing device, setting a coupon refund value; using the computing device, selling to a buyer at least one of the articles and at least one of the coupons, at the base price plus the coupon price multiplied by a number of coupons sold with each of the articles; and using the computing device, refunding the buyer the coupon refund value for each coupon sold to the buyer and used by a buyer for buying the article; where the buyer is entitled to distribute the at least one coupon, and where the coupon entitles a buyer using the client computing device communicating with the server computing device to buy at least one of the articles and at least one of the coupons.

Further according to another aspect of the present invention there is provided a computer program product, stored on one or more non-transitory computer-readable media, including instructions operative to cause a programmable processor to perform the following steps: enabling a user to set a base price for an article of the plurality of articles, enabling a user to set a coupon price, the coupon entitling a buyer to buy an article using the method; enabling a user to set a coupon refund value; enabling a user to buy at least one of the articles at the base price and at least one of the coupons at the coupon price; and refunding the buyer the coupon refund value for each coupon sold to the buyer and used by another user for buying the article; where the buyer is entitled to distribute the at least one coupon, and where the coupon entitles a user to buy at least one of the articles and at least one of the coupons.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of a social network for coupon distribution and a distribution system for operating the social network;

FIG. 2 is a simplified illustration of a distribution system serving a plurality of social networks 10;

FIG. 3 is a simplified illustration of a distribution system serving a plurality of billing systems;

FIG. 4 is a simplified flow chart of a software program executed by the distribution system;

FIG. 7 is a simplified illustration of an ad-hoc multi-level marketing system;

FIG. 8 is a simplified illustration of coupon distribution process using the ad-hoc multi-level marketing system;

FIG. 9 is a simplified block diagram of the data structure of the ad-hoc multi-level marketing system; and

FIG. 10 is a simplified block diagram of an ad-hoc multi-level marketing process executed using the ad-hoc multi-level marketing system.

### DETAILED DESCRIPTION OF THE INVENTION

The principles and operation of a method and a system for operating a social network for coupon distribution according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it is described.

The purpose of the system and method of operating a network for coupon distribution described herein is to provide means for creating and managing a network of buyers and sellers for a specific product. In this network, each buyer may also be a distributor, (or a seller), and preferably but not exclusively, each buyer is a distributor (or a seller) of a plurality of products.

A product in this document is anything that may be sold or bought. Thus, a product may be a physical article, a service, content, the license for using content, a ticket for obtaining a service, such as attending a show, an entitlement for a product, a service or content, etc. Therefore, in this document, the terms product, article, entity, and entitlement may be used interchangeably unless specified otherwise.

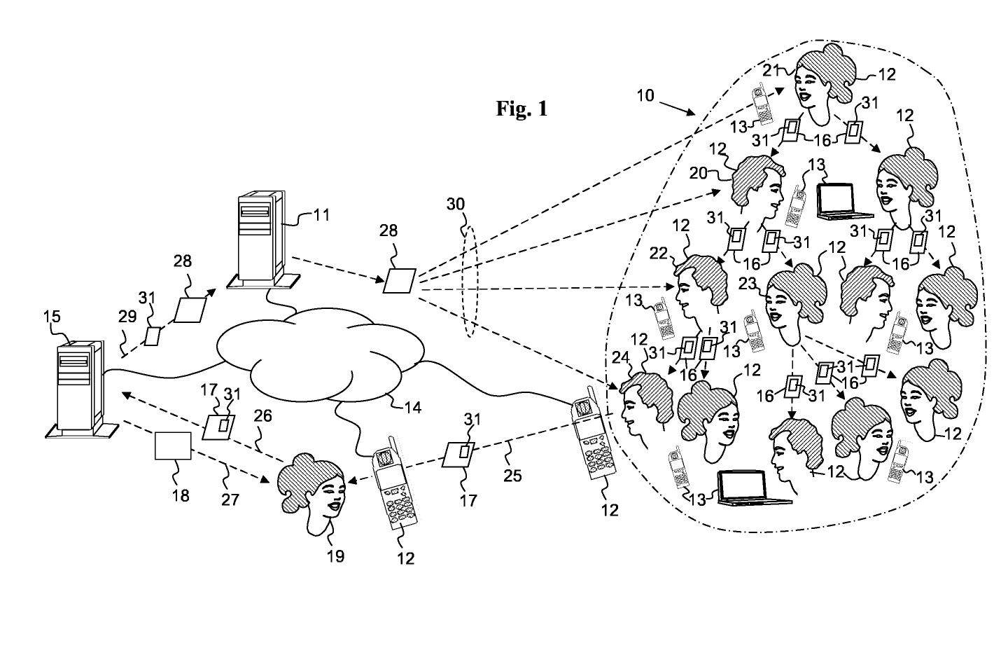

Reference is now made to FIG. 1, which is a simplified illustration of a social network for coupon distribution 10 and a distribution system 11 for operating the social network 10, according to a preferred embodiment of the present invention.

As shown in FIG. 1, the social network 10 includes users 12, each operating a computational device 13 that can communicate over a network 14 with either the distribution system 11 or the billing system 15 or, preferably, with both systems 11 and 15.

Network 14 is preferably a public communication network, preferably a data communication network such as a wide area network (WAN), a local area network (LAN) a personal area network (PAN), a wired network and/or a wireless network, and/or a public land mobile network (PLMN), and/or a cellular network, and/or any combination thereof. Preferably network 14 is the Internet. Computational devices 13 are preferably computers and/or laptops, and/or tablet computers, and/or PDAs, and/or mobile telephones and/or smart phones, etc. The distribution system 11 and/or the billing system 15 are preferably using at least one computational device, such as network computers or servers.

It is appreciated that distribution system 11 and billing system 15 can be implemented in a single computational device or platform as well as cloud of computational devices or platforms. It is appreciated that distribution system 11 and billing system 15 can be operated by a single business entity, however, preferably, the distribution system 11 and the billing system 15 can be operated by different business entity. In this respect, the business entity operating the distribution system 11 provides coupon distribution service to the business entity operating the billing system 15.

The users 12 of a social network 10 are preferably arranged in a hierarchical structure (or a tree-like structure). Preferably, each user 12 invites one or more users 12 to join the network, thus creating a social network. A user 12 preferably invites other users by sending each of them an invitation in the form of a coupon or an entitlement 16. The entitlement 16 enables the receiving user at least the following actions:
A) Join social network 10.
B) Send invitations (e.g. entitlement 16) to other users to join social network 10.
C) Send coupons 17 to other users.
D) Buy a particular article 18, present the coupon 17, and receive a price reduction for the coupon (thus redeeming the coupon).

The entitlement 16 and the coupon 17 may be the same entity, being the entitlement 16 when used as an invitation for actions A and B, and being coupon 17 when used for actions C and D. It is appreciated that the user redeeming the coupon may be a member of the social network 10 such as a user 12, or a user outside the social network 10 such as a user 19.

Optionally, actions A, B, C and D may be conditioned on each other. For example:
Joining the social network 10 (action A) may be conditioned on buying an article 18 (action D).
Sending invitations (e.g. entitlement 16) to other users to join social network 10 (action B) may be conditioned on joining the social network 10 (action A).
Sending coupons 17 to other users (action C) may be conditioned on joining the social network 10 (action A).
Sending invitations (e.g. entitlement 16) to other users to join social network 10 (action B), and/or sending coupons 17 to other users (action C) may be conditioned on buying an article 18 (action D).

Preferably, action D, involving presenting coupon 17 and buying of article 18, is executed by a user 12 or 19 using a computational devices 13 to access the billing system 15. Billing system 15 may be implemented as a web server and/or a human operated call center.

Article 18 may be anything on sale, such as a product, service, and/or content.

Upon receiving an entitlement 16 a user 12, such as user 12 designated by numeral 20, may join social network 10 as a subordinate of the user 12 who sent the entitlement 16, such as user 12 designated by numeral 21. After joining social network 10 a user 12 may send invitations (e.g. entitlement 16) to other users to join social network 10. Thos who will accept this invitation and join social network 10, such as users 12 designated by numerals 22 and 23, will be subordinates of user 20. This creates the hierarchical, or tree-like, structure of social network 10. Therefore, preferably, an entitlement 16 identifies the sender, that is the user 12 who sent the entitlement, so that distribution system 11 can register the receiver of an entitlement 16 as a subordinate of the sender. Hence creating a subordinate-line, such as the line of users 12 including the users 21, 20, 22 and 24, being a chain of users, and/or a sequence of users, providing entitlements (or coupons).

It is appreciated that a social network 10 is created by nominating one or more root users (or tree-root users) 12 such as user 21. User 21 then starts the distribution process branching the tree thereof.

Preferably, a social network 10 may include one or more independent trees of users 12. The trees are independent in the sense that any particular user 12 is a member of a single tree only, and/or that no user 12 belongs to two or more trees. A social network 10 is characterized in that it is associated with a particular coupon campaign.

As seen in FIG. 1, entitlements 16 progress down a tree in social network 10 and users 12 send coupons 17 to users 19 (such as step 25). Any user 12 and/or 19 may redeem a coupon 17 using billing system 15(such as step 26). Responsively, billing system 15 sends an article 18 to the buying user 19, such as in step 27 (or a user 12) and an associated commission (or a message containing an entitlement to a commission) 28 to distribution system 11, such as in step 29. Responsively, distribution system 11 distributes the commission 28 among users 12 (step 30) who are members of the subordinate-line above the user 12 who sent the redeemed coupon. In the exemplary preferred embodiment described with reference to FIG. 1 the subordinate-line includes the users 21, 20, 22 and 24.

Step 30 of distributing of the commission 28 to the users 12 of the subordinate-line can be considered as action E, in addition to actions A, B, C, D discussed above.
E) Receiving at least a part of a commission on a coupon redeemed by another user wherein the redeemed coupon is directly or indirectly associated with the receiving user.

It is appreciated that optionally but preferably the distribution of the commission 28 in step 30 is limited to users 12 who registered to the social network 10. If such registration is conditional, for example on the registered user buying an article 18, a user 12 that did not buy an article 18 may be excluded from the step 30 of distributing of the commission 28.

In other words, the conditioning of the actions A, B, C, D (and E) as discussed above may be ordered or unordered. Ordered conditioning means that, for example, a user must first buy an article (action D) and only then register (action A). This implies that billing systems 15 reports to distribution system 11 that a user has bought an article (action D) before the user can register (action A). Alternatively, a user may register (action A) before buying an article, but the user's entitlement to the commission is effected only after the user has bought an article. Thus, billing systems 15 does not have to report to distribution system 11 to enable registration.

Therefore, the entitlement 16 and/or the coupon 17 preferably include identification means 31 for uniquely identifying each entitlement 16 and/or the coupon 17 that is obtained by a user 12 from the distribution system 11. The distribution system 11 preferably associates this identification means with the user 12 who sent the entitlement 16 and/or the coupon 17. Thus, this identification means also identifies the user 12 who sent the entitlement 16 and/or the coupon 17.

Identification means 31 may be a numeral or an alphanumeric string that is unique in the system. For example, the identification means may be a serial number, a large enough random number, a structured number that includes serial numbers identifying a product, a campaign, a social network, a tree of users, and a user within a tree.

Preferably, when a user 12 or 19 redeems a coupon 17 while buying an article 18 using billing systems 15, billing systems 15 obtains the identification means 31 of the redeemed coupon 17 (in step 26) and then transfers the identification means 31 to the distribution system 11 (in step 29). The distribution system 11 can then identify the sending user 12 (user 24 in the example of FIG. 1) and the chain of users 12 (subordinate-line) leading from the tree-root user (user 21 in the example of FIG. 1) to the sending user (i.e. users 21, 20, 22 and 24 in the example of FIG. 1). Distribution system 11 can then distribute the commission 28 among this chain of users. Preferably the distribution system 11 distributes the commission 28 among this chain of users according to the position of each user in the subordinate-line.

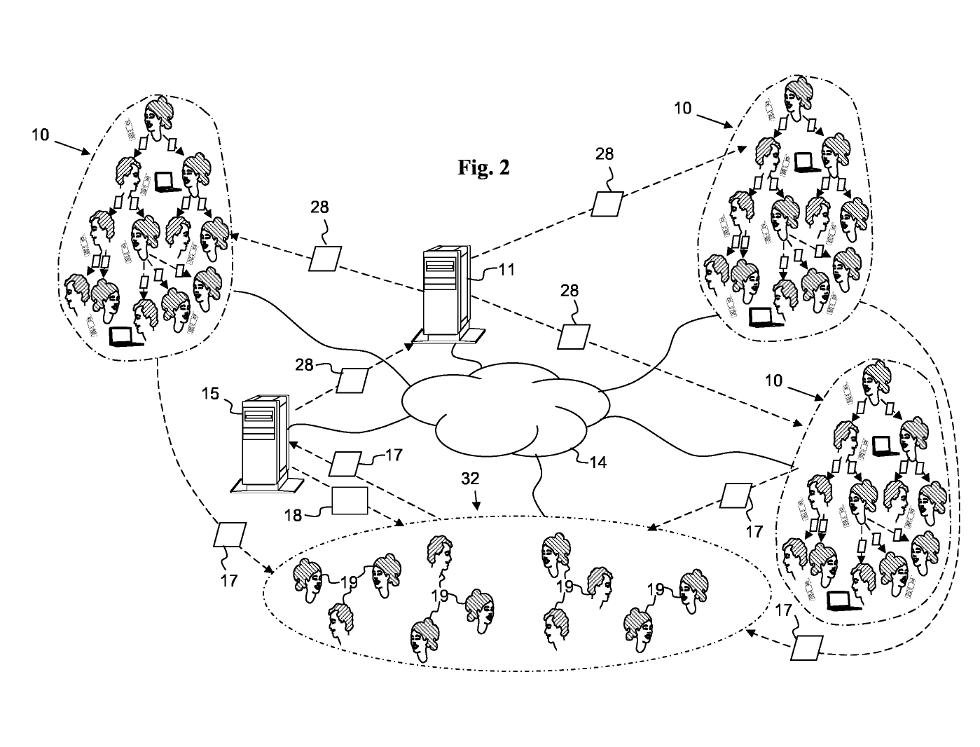

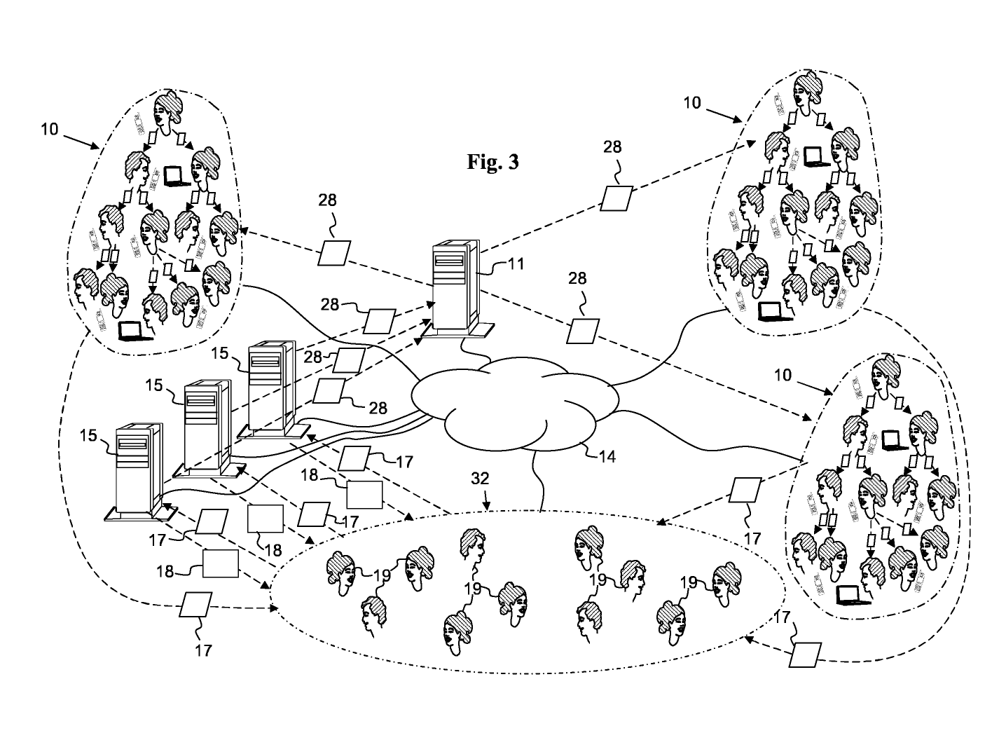

Reference is now made to FIG. 2, which is a simplified illustrations of a distribution system 11 serving a plurality of social networks 10, and to FIG. 3, which is a simplified illustrations of a distribution system 11 serving a plurality of billing systems 15, according to a preferred embodiments of the present invention.

As seen in FIG. 2, the distribution system 11 serves a plurality of social networks 10, each including at least one tree of users 12, and, optionally but preferably, the general public 32, including users 19.

It is appreciated that a user 19, being a user outside a particular social network 10, may be a member of another social network 10. Furthermore, it is appreciated that a user 12 may be a member in two different social networks 10. Thus, a user 12 may be a member in two different user-trees if these user-trees belong to two different social networks 10.

In the exemplary preferred embodiment described with reference to FIG. 2 the plurality of social networks 10 are served by the same billing system 15. Preferably, these social networks 10 operate different coupon campaigns for the same company operating the billing system 15. Typically, different coupon campaigns are associated with different types of articles 18 (different products).

As seen in FIG. 3, the distribution system 11 serves a plurality of billing system 15, as well as a plurality of social networks 10 each including at least one tree of users 12, and, optionally but preferably, the general public 32, including users 19.

It is appreciated that a user 19, being a user outside a particular social network 10, may be a member of another social network 10. Furthermore, it is appreciated that a user 12 may be a member in two different social networks 10. Thus, a user 12 may be a member in two different user-trees if these user-trees belong to two different social networks 10.

In the exemplary preferred embodiment described with reference to FIG. 3 the plurality of social networks 10 are served by a plurality of billing systems 15. Preferably, each billing systems 15 serves different social network(s) 10. Preferably, these social networks 10 operate different coupon campaign for the same company operating the billing system 15. Typically, such different coupon campaigns are associated with different vendors of articles 18 (preferably different types of articles 18), each vendor operating its own billing system 15 and selling its own articles 18 executing a different coupon campaign and using a different social network 10 (one or more).

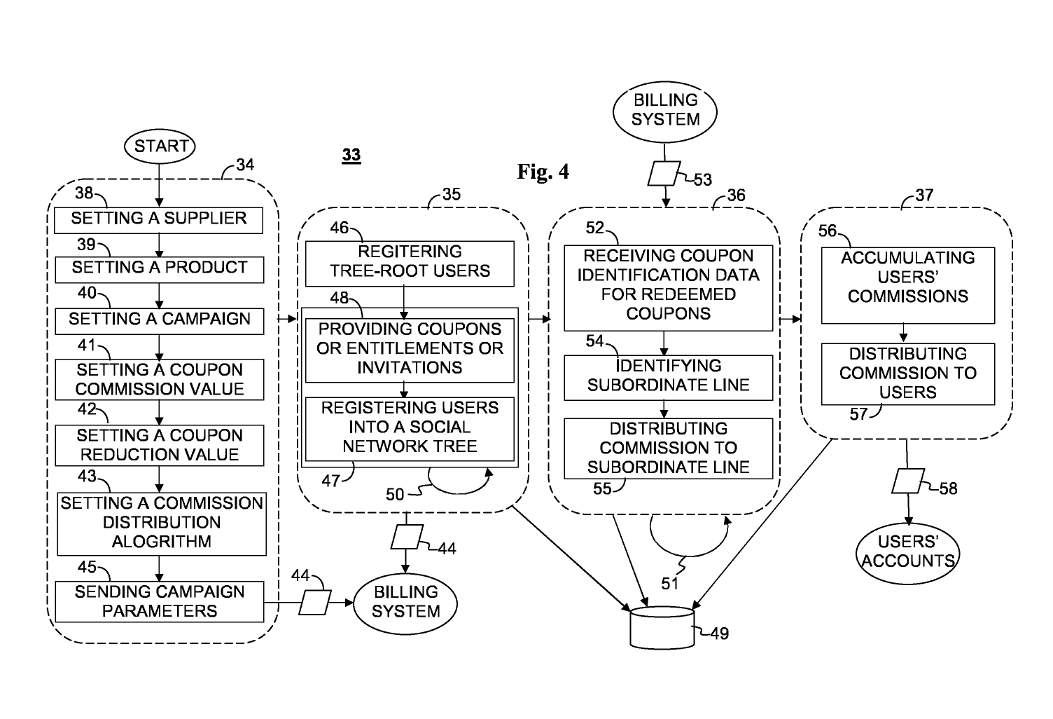

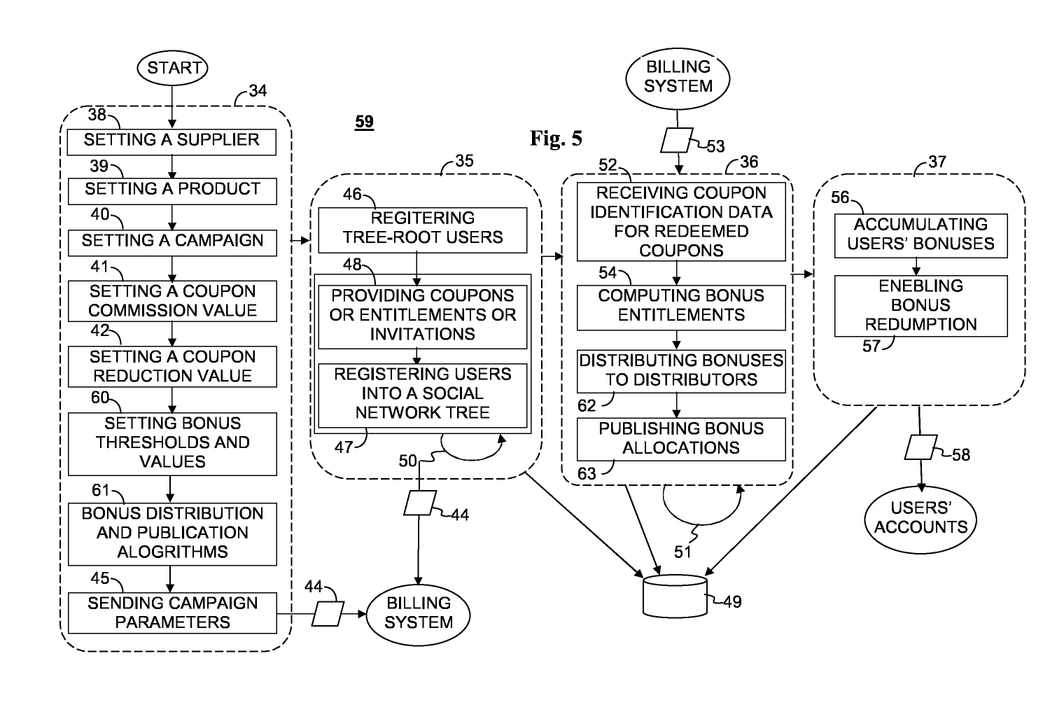

Reference is now made to FIG. 4, which is a simplified flow chart of a software program 33 executed by distribution system 11 according to a preferred embodiment of the present invention.

Preferably, the distribution system 11 is a data processing system including a processor executing software program 33. Software program 33 preferably includes four main modules: setup module 34, coupon distribution and registration module 35, commission distribution module 36, and commission payment module 37.

As seen in FIG. 4, executing software program 33 preferably starts with setup module 34 setting the parameters of a coupon distribution campaign. Setup module 34 preferably starts by setting a supplier (step 38), a product (step 39), and a campaign (step 40). These setup steps provide means for interfacing between the distribution system 11 and the billing system 15 such as a shared file format or a communication protocol. Using such interfacing means the billing system 15 can recognize a coupon 17 and associate it with a supplier, and/or a product such as entity 18, and/or a particular campaign. The data exchanged via the interfacing means preferably includes the identification means 31 described above with reference to FIG. 1. Such interfacing means may be used in steps 26 and/or 29 also described above with reference to FIG. 1.

Setup module 34 preferably continues by setting campaign parameters such as the coupon commission value (step 41), coupon price reduction value (step 42) and the commission distribution algorithm (step 43).

Coupon price reduction is the value the billing system 15 should deduct from the list price when selling a product such as entity 18 to a buyer presenting a coupon 17 associated with the correct supplier and/or product and/or campaign.

Coupon commission is the value the billing system 15 should transfer to the distribution system 11 for each coupon redeemed (presented by a buyer when buying an entity 18). The distribution system 11 should then distribute the coupon commission among users 12 forming the associated subordinate-line (or user chain, or user sequence).

Commission distribution algorithm is the manner in which the distribution system 11 distributes the coupon commission among a plurality of the users 12, preferably users 12 forming the subordinate-line associated with a redeemed coupon.

For example, the distribution system 11 may equally distribute the coupon commission so that each user 12 of the associated subordinate-line receives the same share of the coupon commission.

Alternatively, the commission is distributed among the users according to the user's position in the subordinate-line (chain of users providing entitlements). For example, the lowest user 12 in the subordinate-line (the user 12 who sent the coupon 17 to the buying user, such as user 24 of FIG. 1) receives half of the coupon commission, the next higher user 12 (such as user 22 of FIG. 1) receives half of the remainder (the coupon commission minus the sum allocated to user 24), the next higher user 12 (such as user 20 of FIG. 1) receives half of the remainder (the coupon commission minus the sums allocated to users 24 and 22), and so on.

Preferably, a certain part of the coupon commission is allocated to the company operating the distribution system 11.

Preferably, the distribution system 11 then creates a bank (collection) of identification means 31, such as unique coupon identification data (coupon IDs 44) and sends it to the billing system 15 (step 45). It is appreciated that the coupon identification mechanism refers both to entitlements 16 and coupons 17 (whether these are different entities or the same entity).

Preferably, the coupon identification is a unique number or alphanumeric string that identifies the user who sends the entitlement 16 and/or the coupon 17. Preferably, the coupon identification identifies at least one of the sending user 12, the billing system 15, the supplier, the product, the campaign, the reduction value, and the commission value. However, some of these items may be embedded in the entitlement 16 and/or the coupon 17 in other manners. For example, a clickable Uniform Resource Locator (URL) can identify the billing system 15, and/or supplier, and/or product, and/or campaign, and/or reduction value. That is, a URL leading to the appropriate web page preferably provided by the billing system 15 and associated with the relevant supplier, product, campaign, and/or reduction value.

Software program 33 preferably proceeds with coupon distribution and registration module 35 step 46 by registering one or more tree-root users 12 such as user 21 of FIG. 1. Each such tree-root users then sends one or (preferably) more coupons (or entitlements or invitations 16) to other users. Such users may then register (step 47) as a user 12 who is a subordinate of the sending user and then retrieve and send (step 48) further coupons 17 or entitlements or invitations 16 to other users. Thus, by repeating steps 47 and 48 the coupon distribution and registration module 35 creates one or more trees of users 12, thus forming a database 49 of the coupon distributing social network 10. Using the identification means 31, the database 49 enables the distribution system 11 and software program 33 to associate a particular user 12 with a particular coupons 17 (and/or entitlements or invitations 16).

Each of the coupons 17 or entitlements or invitations 16 provided by the coupon distribution and registration module 35 in step 48 is associated, preferably using its coupon identification, with a user 12 (the sending user) who retrieved the coupon (or entitlements or invitations) and then sent it to other users. Thereafter, when a new user registers, the new user presents the coupon (or entitlements or invitations) to the coupon distribution and registration module 35 that identifies the coupon, preferably using its coupon identification (e.g. identification means 31), and thus identifies the sending user 12. Thus, the coupon distribution and registration module 35 registers the new user 12 as a subordinate of the sending user 12.

Alternatively, instead of creating a bank of coupon identification data 44 and sending it to the billing system 15 in step 45, the distribution system 11 executing the coupon distribution and registration module 35 may create coupon identification data 44 on-the-fly and send it to the billing system 15.

Software program 33 preferably proceeds with commission distribution module 36 to distribute the commissions for the redeemed coupons among the members of the social network 10, and particularly among the members of the subordinate-line associated with the redeemed coupon

It is appreciated that coupon distribution and registration module 35 and commission distribution module 36 may be executed sequentially, or, alternatively, may be executed in parallel. When the coupon distribution and registration module 35 and the commission distribution module 36 are executed in parallel the social network 10 can further develop while coupons are redeemed and commissions are collected and distributed. Such network development may include developing existing trees of users 12 or creating new trees of users 12. When executed in parallel both coupon distribution and registration module 35 and the commission distribution module 36 are executed repeatedly as indicated by steps 50 and 51.

It is appreciated that while coupon distribution and registration module 35 and/or commission distribution module 36 are operative users 12 and/or users 19 may present and/or redeem coupons 17 in the billing systems 15, preferably buying articles 18.

The distribution system 11 executing the commission distribution module 36 then receives (step 52) from the billing system 15 coupon redemption data 53 containing the coupon identification data of redeemed coupons. Like coupon ID data 44 coupon redemption data 53 can be received in the form of a file, or as on-the-fly communication data.

The commission distribution module 36 then proceeds to step 54 to identify the coupon and thereafter the user 12 who sent the coupon and the subordinate-line leading, from the tree-root user 12 to the sending user 12.

The commission distribution module 36 then proceeds to step 55 to distribute the commission among the users 12 of the subordinate-line according to the commission distribution algorithm.

Software program 33 then preferably proceeds with commission payment module 37 to accumulate (step 56) the commission collected for each user 12 from the various redeemed coupons 17 and to distribute (step 57) the earned commissions 58 to the users 12 of the social network. Step 57 may be executed continuously, or from time to time, or when the campaign terminates.

Thus, software program 33 enables a first user 12 to provide a second user 12 with an entitlement 16 to a coupon 17, the entitlement 16 enabling the second user 12 to obtain a coupon 17, the coupon 17 comprising a price reduction for buying an article 18, and a commission. Upon the purchase of the article 18 using coupon 17 the software program 33 provides the commission to the first user 12, preferably distributing the commission among the subordinate tree leading from the tree-root user to the first user.

In some marketing situations the basic commission is too small to provide an effective incentive for a distributor. One way of resolving such situation is to distribute a “higher then equal” share of the commission among a smaller share of the distributors. In other words, the total commission is divided among a relatively small number of distributors. There are two main types of methods for such uneven distribution of benefits: bonuses and lottery.

Bonus distribution is based on any type of measured achievement. Preferably, the achievement is evident before the bonuses are allocated to their recipients. The following is a list of exemplary achievements that may serve as the basis for bonus distribution:
Number of emails sent by a distributor to prospected buyers.
Number of emails sent by a distributor and opened by prospected buyers.
Number of sub-ordinate distributors recruited directly by a distributor.
Number of sub-ordinate distributors recruited by a distributor, including some portion of indirectly recruited distributors (for example, distributors recruited by sub-ordinate distributors).
Number of sales attributable directly to a distributor.
Number of sales attributable directly to a distributor, including some portion of indirect sales (for example, sales attributed to sub-ordinate distributors).
Value of sales attributable directly to a distributor.
Value of sales attributable directly to a distributor, including some portion of indirect sales (for example, sales attributed to sub-ordinate distributors).
A subscriber is entitled to a bonus if the subscriber reaches a predetermined level, or threshold, such as 1,000 emails, or 50 sub-ordinate distributors, or 15 sales, or a cumulated value of sales such as $150, etc. There may be a set of levels or thresholds, such as:
1,000, 2,500, and 10,000 emails.
50, 75, and 100 sub-ordinate distributors,
15, 30, and 50 sales

where the higher the level the higher is the value of the bonus. It is appreciated that any combination thereof is contemplated.

To increase the incentive to the distributors the distribution system 11 preferably informs the distributors of the status of their achievements, periodically (e.g. every week) or conditionally (e.g. upon reaching a predefined intermediate threshold or upon achievement of a leading distributor, etc.), such as:
when additional 100 emails were sent, or opened;
when additional 10 sub-ordinate distributors are added; when a sale is recorded.

The allocation or entitlement of bonuses to distributors may be done on a time basis, such as:
1 1,000, 2,500, and 10,000 emails sent each week.
10, 15, and 20 sub-ordinate distributors added each month.
5, 10, and 15 sales in a predetermined period.

The allocation or entitlement of bonuses to distributors may be done on a race basis, that is, on the basis of first to achieve, such as:
the first 500 distributors that reach 1,000, 2,500, and 10,000 emails sent; the first 100 distributors that recruit 50, 75, and 100 sub-ordinate distributors.
The first 10 distributors that achieve 5, 10, and 15 sales.

Any combination of the bonus allocation methods described above is contemplated, including bonuses allocated to the first distributors to achieve a threshold within a predetermined period of time.

The bonuses may be unrelated to revenues or commissions, such as the bonuses allocated to the sending of emails or recruiting distributors. The bonuses may therefore be limited by their total number and/or by their cumulative value. Alternatively, the number of the bonuses and/or their cumulative value may depend on the revenues or commissions collected. In such case the number of the bonuses and/or their cumulative value may increase with time as the revenues or commissions are collected.

To increase the incentive to the distributors the distribution system 11 preferably informs a distributor when a bonus is entitled to the distributor. Preferably, the distribution system 11 also informs a distributor about bonuses entitled to other distributors. If the bonuses are limited the distribution system 11 may also inform the distributors about bonuses remaining for allocation.

Benefits distributed to distributors may include commission from revenues and/or a predefined and/or pre-allocated funds, a sum of money, or any other collection of articles of a corresponding value (in excess or independently of the revenues or commissions). The benefit or prize offered for a particular bonus type and/or level may include a sum of money and/or an article of a perceived similar value. Preferably, the benefit or prize may include a number of such articles and the winning distributor may chose one of these prizes.

Reference is now made to FIG. 5, which is a simplified flow chart of a software program 59 executed by distribution system 11 and including distribution of bonuses, according to a preferred embodiment of the present invention.

Software program 59 is similar to software program 33 with bonus-related steps 60, 61, 62, and 63 replacing the commission-related steps of software program 33. It is appreciated that it is possible to have a software program integrating commission-related steps and bonus-related steps, and the separation herein is to simplify the presentation.

In step 60 a user, preferably a campaign administrator, preferably sets the bonus thresholds, and then, in step 61, the bonus distribution algorithm and bonus publication algorithm. In step 62 the distribution module 36 compares distributors achievements with their respective thresholds and distributes bonuses to distributors according to the bonus distribution algorithm of step 61. In step 63 the distribution module 36 publishes to selected distributors their achievements as well as bonus allocation statuses. In steps 56 and 57 the commission payment module 37 accumulates the bonuses (and commission, if applicable) to the user account and then enables the user to redeem the cumulated bonus (and commission, if applicable).

As discussed above, benefits may be allocated or entitled to distributors by distributing commissions along a tree branch, by allocating bonuses, or thorough a lottery mechanism and any combination of these methods is contemplated herein.

In such case the cumulative commission or part of it is divided into one or more prizes of the same value or different values and then the prizes are distributed among distributors winning the lottery. The participation of a distributor in the lottery may depend on certain achievements. That is, to participate in the lottery a distributor has to make a predefined achievement, such as the achievements or threshold listed above for the allocation of bonuses. It can therefore be seen that a bonus includes a (virtual) lottery card, and a distributor may be allocated a number of lottery cards according to the distributor's achievements.

Reference is now made to FIG. 6, which is a simplified flow chart of a software program 64 executed by distribution system 11 and including distribution of lottery prizes, according to a preferred embodiment of the present invention.

Software program 64 is similar to software program 33 with bonus-related steps 65, 66, 67, 68, and 69, replacing the commission-related steps of software program 33. It is appreciated that it is possible to have a software program integrating commission-related steps and bonus-related steps, and the separation herein is to simplify the presentation.

In step 65 a user, preferably a campaign administrator, preferably sets the lottery terms and conditions, such as participation thresholds and prizes values. In step 66 the distribution module 36 allocates virtual lottery participation cards to users according to users' achievements and according to the participation rules and threshold values as set by the lottery terms and conditions in step 65. The distribution module 36 then proceeds to step 67 to determine if a condition for lottery event is met, according to the lottery terms and conditions set in step 65. The distribution module 36 then proceeds to step 68 to perform the lottery by drawing the predefined number of users' cards and distributing prizes to the winners. In step 69 the distribution module 36 publishes the lottery results. Thereafter, the commission payment module 37 accumulates the lottery prizes (as well as bonuses and commission, if applicable) to the users' accounts and then enables the users to redeem the prizes (as well as the bonuses and commission, as applicable).

Preferably, the distribution system 11 allocates commissions, and/or bonuses, and/or lottery prizes, to people (e.g. individuals) involved in a sales campaign or promoting a particular product or service, such as by distribution of coupons, such as virtual coupons. These individuals are not employees of the seller or the company operating distribution system 11, and may not be their customers. Therefore, the identity and/or number of the distributors (i.e. the individuals engaged in the abovementioned sales campaign or promotion) is unknown to the company before the campaign is launched. Therefore, the identity and/or number of the distributors are not known to the distributors as well. The distributors are recruited to the campaign on a voluntary basis, and via their own social network. The allocation of the benefits to distributors participating in a particular campaign or promotion depends on their particular individual and/or cumulative achievements. Hence, the benefits allocated and/or cumulated to a campaign are distributed between the entitled participants substantially based on the individual achievement, and their use of their social network.

Therefore the distribution system 11 collects (registers) distributors, builds and manages the distributors network (tree), and allocates commissions, and/or bonuses, and/or lottery prizes, to distributors according to the development of the sale campaign. The development may be related to the development of the distributors network, sales, and/or revenues. Preferably, the registration of distributors, and/or the distribution of the benefits to the subscribers, is executed while the campaign is ongoing.

It is appreciated that the distribution system 11 allocates commissions, bonuses and prizes to users within a distribution tree according to their respective contribution to the development of the distribution tree, and the results of the distribution, or selling campaign, where the distribution tree is developed ad-hoc for a particular product or service or for a predefined group of products and/or services. It is appreciated that the distribution system 11 manages the development of the distribution tree by distributing coupons to new users, where the coupons are allocated to newly registered distributors in a manner that enables distribution system 11 to identify each distributor according to the coupon the distributor sends to other users.

The principles and operation of a method and a system for ad-hoc multi-level marketing according to another embodiment of the present invention is described herein with reference to the following drawings and accompanying description.

The purpose of the system and method of operating an ad-hoc multi-level marketing method, or system, described herein is to provide means for creating and managing a network of buyers and sellers for a specific product. The network, or tree, of buyers-sellers is developed ad hoc for a particular product or service (or a group of products and/or services). In this network, each seller (or distributor) is also a buyer, and preferably but not exclusively, each buyer is a distributor (or a seller) of a plurality of products. In the ad-hoc multi-level marketing method and system described below, each buyer-seller takes a certain risk, by paying a premium price, to be entitled to a larger discount on the article bought.

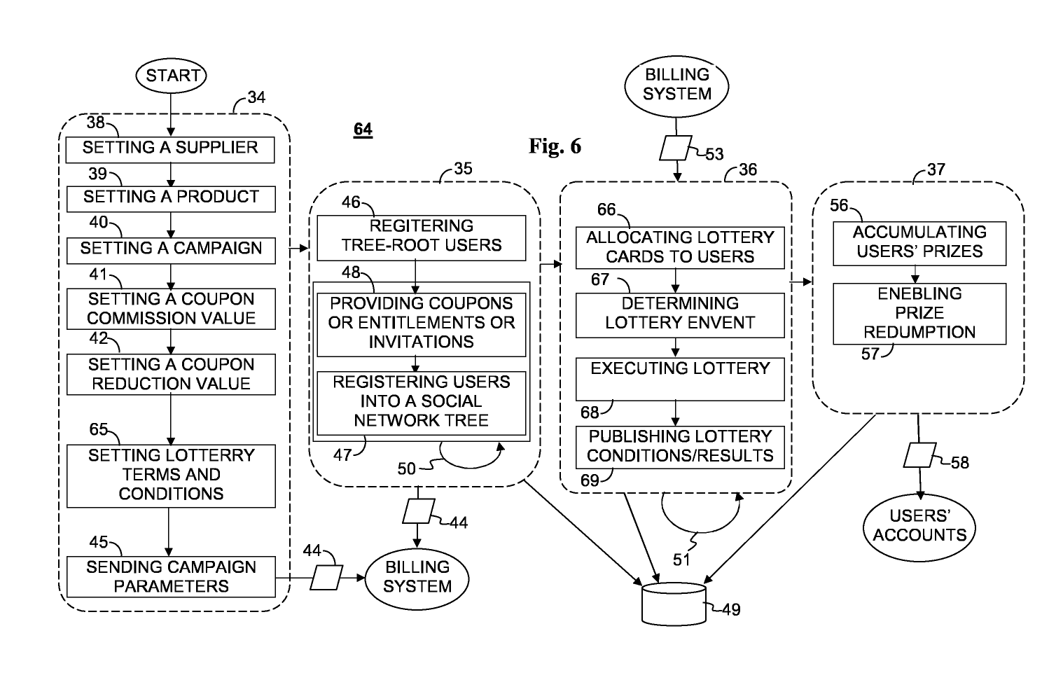

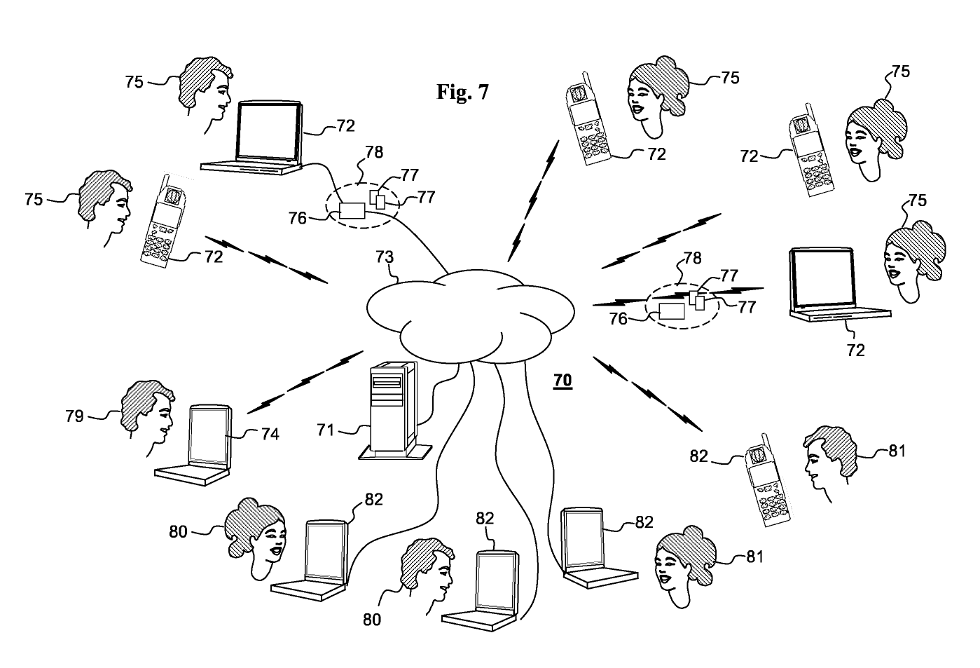

Reference is now made to FIG. 7, which is a simplified illustration of an ad-hoc multi-level marketing system 70 according to a preferred embodiment of the present invention.

As shown in FIG. 7, the ad-hoc multi-level marketing system 70 includes at least one server computing device 71 and a plurality of client computing devices 72 communicating with the server computing device 71 over one or more networks 73. The server computing device 71 is preferably connected to at least one administration terminal 74.

The server computing device 71 may be any computing device or a network or a cloud of computing devices including at least one processor for processing computer software program associated with the ad-hoc multi-level marketing service 10 and storage for storing the software program as well as relevant information and databases.

The server computing device 71 may be operated directly by the entity operating the ad-hoc multi-level marketing service 10 or, alternatively, the entity operating the ad-hoc multi-level marketing service 10 may rent or lease or otherwise obtain processing power and/or storage and/or software services from other business entities.

The server computing device 71 may be any type of computing device such as a computer, a personal computer, a desktop computer, a mobile computer such as a laptop computer, a tablet computer, a PDA, etc., a mobile communication device such as a cellular telephone, a smart phone, etc., or their plurality or any combination thereof.

The client computing devices 72 may be any type of computing device with a user interface such as a computer, a personal computer, a desktop computer, a mobile computer such as a laptop computer, a tablet computer, a palm computer, a PDA, etc., a mobile communication device such as a cellular telephone, a smart phone, etc. Typically and preferably, the client computing devices 72 operates a browser for browsing the Internet or a similar facility for interacting over the Internet. However, the client computing devices 72 may also be a regular fixed-line or mobile telephone connected with the server computing device 71 via a voice-response system, etc. Alternatively, the client computing device 72 uses a client software program for communicating with the server computing device 71.

Network 73 is any type of communication network, or a plurality of communication networks or any combination of communication networks. Such communication networks may be any type of wide area network (WAN, metropolitan area network (MAN), local area network (LAN), personal area network (PAN), short range communication (SRC), near field communication (NFC), etc. Any of these networks may be fixed, cable-based, wireless, mobile, cellular, etc. For example, network 73 may use any of 3G, 4G, GSM, CDMA, LTE, WiMAX, etc. technologies. Preferably network 73 uses packet switched communication technology such as the Internet Protocol (IP). Preferably, network 73 may be any type of public network such as the telephone network, and/or the cellular telephone network and/or the Internet, and/or a wireless Internet network or cellular Internet network. Preferably, network 73 supports the Internet, or the Web, or W3, or any similar communication standards such as HTML, XML, etc.

The administration terminal 74 may be any type of computing device with a user interface such as a computer, a personal computer, a desktop computer, a mobile computer such as a laptop computer, a tablet computer, a PDA, etc., a mobile communication device such as a cellular telephone, a smart phone, etc. The client computing devices 72 may operate a browser for browsing the Internet or a similar facility for interacting over the Internet, or preferably, a software program for administrating the ad-hoc multi-level marketing system 70.

As shown in FIG. 7, the ad-hoc multi-level marketing system 70 enables users that are buyers 75 to buy articles 76 and coupons 77, preferably as a package 78 of one or more articles 76 and one or more coupons 77.

The term article refers to anything that can be sold and/or bought such as a physical product, content, or service, etc., an admission ticket to any type of show, game, etc., a subscription, etc., an entitlement to buy or use a product or a service, etc. The term coupon refers to any type of entitlement to buy or receive an article as defined above, using the ad-hoc multi-level marketing system 70 and/or the method it implements.

Preferably, the coupon 77 is an entitlement to purchase at least one article 76 or at least one package 78. Preferably a package 78 includes one article 76 and at least one coupon 77 for buying a similar package 78.

Other typical users of the ad-hoc multi-level marketing system 70 are one or more administrators 79, one or more suppliers 80, and one or more sellers 81. Suppliers 80 and/or sellers 81 may use terminals 82, which may be client computing devices 72 or administration terminal 74 or a different type of terminal adapted for their needs and authorizations.

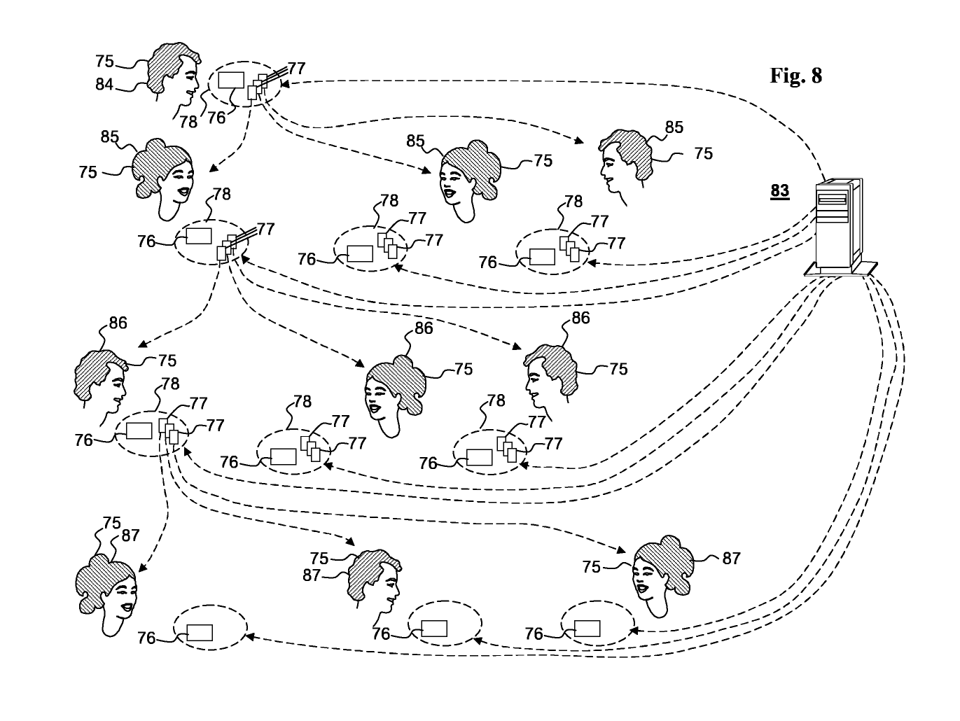

Reference is now made to FIG. 8, which is a simplified illustration of coupon distribution process 83 according to a preferred embodiment of the present invention.

As seen in FIG. 8, a user indicated by numeral 84 preferably buys a package 78 including one or more articles 76 and one or more coupons 77. In the example of demonstrated in FIG. 8 the package 78 always includes one article 76 and three coupons 77. However, it is appreciated that the number of articles 76 and the number of coupons 77 or the ratio between coupons and articles may vary. User 84 is termed herein a root, or first generation, or the primary buyer, or the primary seller, or simply the seller. The seller preferably initiates the distribution process 83. A distribution process may also be named distribution plan, or simply plan.

Distribution process 83 then continuous when user 84—the seller, sends coupons 17 to potential buyers indicated by numeral 85. As seen in FIG. 8 the seller 84 sends three coupons to three users 85, a particular coupon to each user 85. However, seller 84 may send the same coupon to more than one potential buyer and may send the coupons acquired to more users then the number of coupons acquired.

Distribution process 83 then continuous with users 85 each buying a package 78 an article 76 and three coupons 77. Users 85 are considered second generation buyers. As noted above it is possible that the number of articles and coupons may change. Preferably, the number of buyers 85 is not greater then the number of coupons 17 acquired by the seller 84.

Each of buyers 85 distributes the three acquired coupons to other users who become buyers 75 designated by numerals 86 that are considered third generation buyers. In Distribution process 83 there are nine buyers 86 in the third generation though only three are presented in FIG. 8.

Each of buyers 86 distributes the three acquired coupons to other users who become buyers 75 designated by numerals 87, that are considered forth generation buyers. In Distribution process 83 there are twenty seven buyers 87 in the fourth and last generation though only three are presented in FIG. 8.

In the distribution plan 83 shown in FIG. 8 all packages 78 include the same number of articles 76 (one article) and the same number of coupons 77 (three coupons). However, it is appreciated that alternatively the number of articles 76 and/or coupons 77 may change during the evolution of the plan, for example, these numbers may change for each generation.

If the number of articles on sale is limited then the number of coupons is preferably also limited. If the number of articles on sale is limited then the last generation of buyers cannot further distribute coupons for articles and/or packages that are not available. Therefore the number of coupons is less than the number of articles on sale and the last generation of buyers cannot acquire coupons. In the distribution process 83 presented in FIG. 8 the last generation of buyers, being buyers 87, buy articles without coupons. In the distribution process 83 presented in FIG. 8 the number of articles is 1+3+9+27=40 and the number of coupons is 13. The first coupon is provided to the seller 84 and is not shown in FIG. 8.

Optionally, the distribution process may include over-booking. Overbooking means that the distribution process includes more coupons than there are articles on sale. This creates a certain risk for the buyers of coupons, and therefore also an encouragement to distribute their coupons as soon as possible, before the articles are sold-out.

Preferably, the article 76 has a price (base price or list price) for which the article is sold to the buyer. Preferably, the coupon 77 has a price (coupon price) for which a coupon is sold to the buyer of an article 76. Preferably, the coupon 77 has a refund value for which the buyer of the coupon is reimbursed if the coupon is used to buy another article. Preferably, the coupon refund value is higher than the coupon price.

Preferably, the price of the article, plus the price of the coupons sold to the buyer of the article, minus the refund value for the coupons sold to the buyer of the article, is higher than zero. If the price of an article is P, and the coupon price is C, and the coupon refund value is F, and the number of coupons sold to a buyer with each article is N, then preferably:

D=P+(C−F)*N>0 Eq. 1

Preferably, the number of coupons sold with each article (N), the coupon price (C), and the coupon refund value are calculated and arranged so that if all the coupons sold with an article are redeemed, the article is bought at a discount but not at profit. Namely, the package deal (D) as indicated in Eq. 1 includes a certain cost to the buyer.

Preferably, a coupon entitles a person (a potential buyer) to buy one or more articles and optionally one or more coupons, or a package of one or more articles and one or more coupons. Preferably, the coupon entitles a potential buyer to buy the same type of article that was bought by the user who distributed the coupon to the potential buyer. The buyer's purchase of the article at a cost indicates to the potential buyer receiving the coupon from the distributing (higher generation) buyer that the distributing buyer is recommending the article as a genuine consumer of that article. However, the coupon may entitle the potential buyer to buy an article different than the article bought by the distributing, so that the potential buyer is not limited to the very same type of article bought by the distributing buyer.

In the distribution plan 83 shown in FIG. 8 all packages 78 have the same base price, coupon price and refund value. However, it is appreciated that alternatively the base price, and/or the coupon price and/or the refund value may change during the evolution of the plan, for example, these numbers may change for each generation.

In the distribution plan 83 shown in FIG. 8 all packages 78 have the same ration between the number of articles and the number of coupons, which in this case is 3. However, it is appreciated that alternatively this ratio may change. For example, the ratio may change with the evolution of the plan, and/or with each generation, or according to the total number of articles sold, or according to the number of articles distributed, etc.

It is therefore appreciated that the ad-hoc multi-level marketing system 70 enables a user such as a supplier 80, and/or a seller 81, to set a formula that calculates composition of a package 78, including at least one of the parameters of the package 78 including the base price, number of articles, number of coupons, coupon price, and refund value, where the composition is based on the other parameters of the package 78 and optionally on sale parameters such as the generation, the number of articles sold, the number of articles remaining for sale, the number of coupons distributed, the number of coupons redeemed, etc.

Consequently, the ad-hoc multi-level marketing system 70 enables a user such as a supplier 80 to introduce a new article, and thus a supplier 80 and/or a seller 81 can introduce a new campaign or a new plan. The ad-hoc multi-level marketing system 70 then operates concurrently and independently a plurality of such ad-hoc multi-level marketing operations where an article is marketed and/or sold using several different campaigns and/or plans. Similarly, the ad-hoc multi-level marketing system 70 operates concurrently and independently a plurality of such ad-hoc multi-level marketing operations where different types of articles are marketed and/or sold independently of each other.

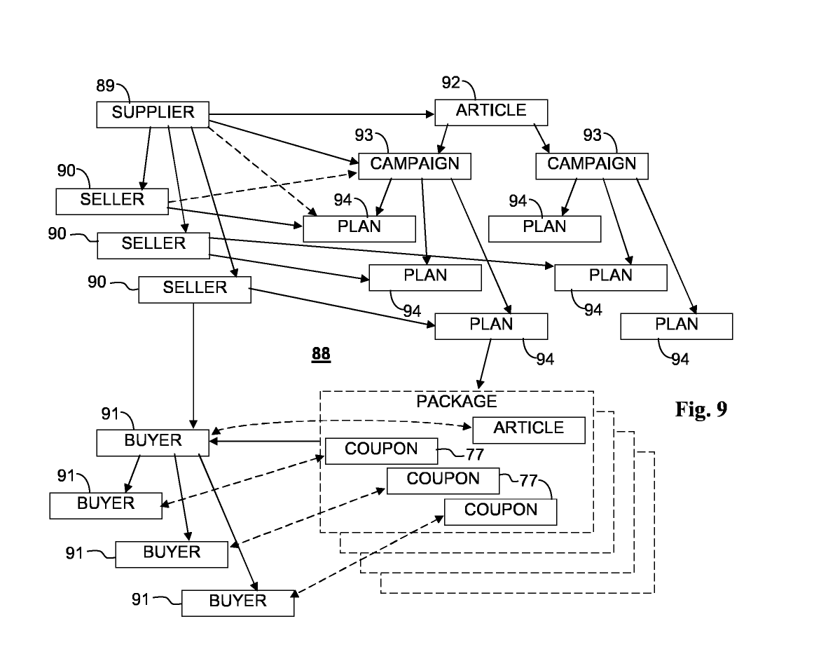

Reference is now made to FIG. 9, which is a simplified block diagram of the data relations in the ad-hoc multi-level marketing system 70, according to a preferred embodiment of the present invention.

Preferably the data elements shown in FIG. 9 and their relations illustrate a database 88 managed by the ad-hoc multi-level marketing system 70.

As shown in FIG. 9, the database 88 includes the following elements or data structures:
One or more supplier records 89, each representing a supplier 80.
One or more seller records 90, each representing a seller 81. Preferably the seller record 90 is created by a respective supplier 80 and is associated therewith.
One or more buyer records 91, each representing a buyer 75.
One or more article records 92, each representing a type of article 76 for sale. Preferably the article record 92 is created by a respective supplier 80 and is associated therewith.
One or more campaign records 93, each representing a campaign for selling a particular type of articles 76. Preferably the campaign record 93 is created by a respective supplier 80 and is associated therewith, but optionally the campaign record 93 is created by a respective seller 81 and is associated therewith.
One or more plan records 94, each representing a plan for selling a particular type of articles 76, preferably to a particular type of potential buyers. Preferably the plan record 94 is created by a respective seller 81 and is associated therewith, but optionally the plan record 94 is created by a respective supplier 80 and is associated therewith.
One or more records of coupons 77, each representing a coupon for buying a particular type of article 76, preferably associated with a particular plan 94. Preferably

Preferably, the ad-hoc multi-level marketing system 70 enables a user such as the supplier 80 and/or the seller 81 to set up parameters of the campaign and/or the plan including the following parameters:
Number of articles on sale
Number of coupons per article
Total number of coupons
Article base price
Coupon price
Refund value per coupon redeemed
Price of articles that are sold without coupons
Number of articles sold at last generation price (without coupons)
Overbook—the number of coupon distributed over the number of articles

It is appreciated the ad-hoc multi-level marketing system 70 may host such database of any type of article on sale, thus hosting a plurality of the database 88.

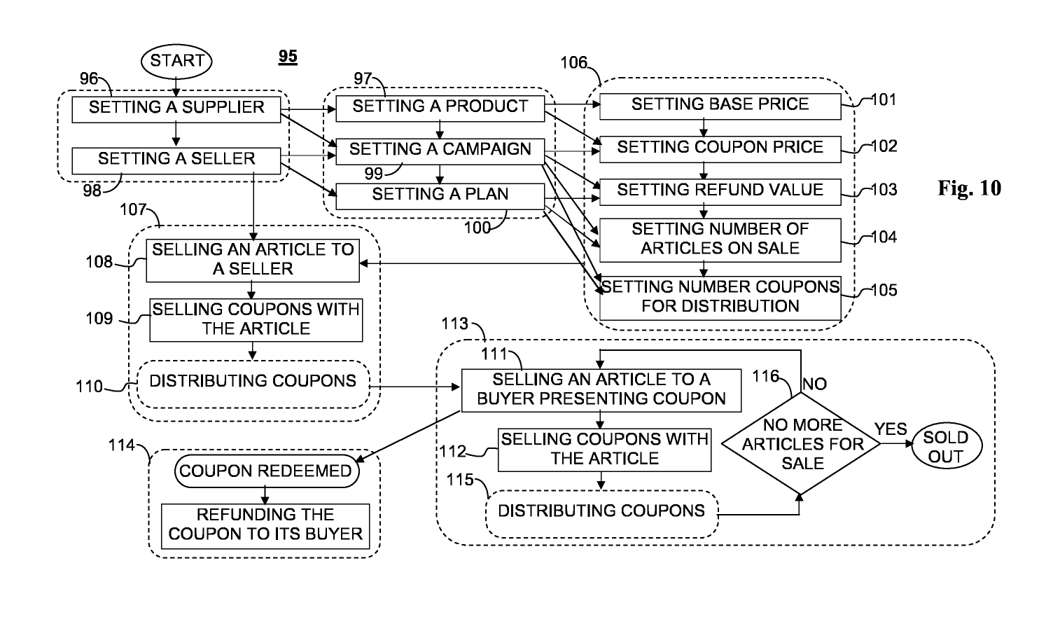

Reference is now made to FIG. 10, which is a simplified block diagram of an ad-hoc multi-level marketing process 95 according to a preferred embodiment of the present invention. The ad-hoc multi-level marketing process 95 is preferably executed by user of the ad-hoc multi-level marketing system 70, and using computer software program associated with the ad-hoc multi-level marketing service 10. The computer software program associated with the ad-hoc multi-level marketing service 10 enables the users to effect the following actions.

As shown in FIG. 10, process 95 preferably starts with step 96 by setting a supplier 80. Typically, an administrator 79 using administration terminal 74 sets the new supplier 80 as a user of the ad-hoc multi-level marketing system 70 with a supplier's identifications and authorizations.

Process 95 preferably continues with step 97 by setting one or more products and/or articles for sale, such as article 76 of FIGS. 7 and 8. Typically, a supplier 80, using terminal 82, sets the new products or articles 76. Process 95 preferably continues with step 98 by setting one or more sellers 81. Typically, a supplier 80, using terminal 82, sets a new seller 81 as a user of the ad-hoc multi-level marketing system 70, or selects an existing seller 81. Typically, the supplier 80 provides the seller 81 with appropriate authorizations to set one or more campaigns and/or plans associated with one or more products and/or articles of the particular supplier 80.

Process 95 preferably continues with steps 99, 100, 101, 102, 103, 104, and 105, with the supplier 80 and/or the seller 81 setting up a campaign (step 99) and a plan (step 100) and their parameters (step 106). The campaign and the plan parameters include: such as setting base price (step 101), setting coupon price (step 102), setting refund value (step 103), optionally setting a number of articles on sale (step 104) and number of coupons for distribution (step 105).

Process 95 then preferably continues with step 107 by selling to at least one buyer 75 a package comprising one or more articles (or products, in step 108) and one or more coupons (step 109). The buyer 75 is preferably a registered user of the ad-hoc multi-level marketing system 70, though the buyer registration process is not presented in FIG. 10. Alternatively, the buyer 75 does not have to be a registered user. Optionally, the process continues in step 110 by enabling the buyer 75 to distribute coupons to other potential buyers. It is appreciated that coupons are preferably distributed to potential buyers using electronic communications means such as email, short message service (SMS), chat services, twitting services, etc.

Process 95 then preferably continues with step 111 by selling to a buyer (starting with the seller) a package containing at least one article 76 (step 112) and at least one coupon 77 (step 113). Preferably, as of the first buyer, a package and/or article is sold only to a buyer presenting a coupon 77. In step 114 the refund value for the coupon redeemed by buying the article in step 111 is delivered to the buyer (of the previous generation) who bought the coupon and sent it to the current buyer.

In step 115 the current buyer then distributes the coupon bought to the potential buyer of the next generation (optionally using ad-hoc multi-level marketing system 70).

In step 116 if there are no more articles to sell, the plan terminates.

It is appreciated that the ad-hoc multi-level marketing system 70 operates the process 95 concurrently and independently for each campaign and/or for each plan, and/or for each type of article.

According to one aspect of the present invention a coupon can be obtained from the ad-hoc multi-level marketing system 70 only when buying an article.

According to another aspect of the present invention the coupon has a price that the buyer pays when obtaining the coupon from the ad-hoc multi-level marketing system 70.

According to another aspect of the present invention the buyer that obtains a coupon from the ad-hoc multi-level marketing system 70 pays additional price for the article bought with the coupon, or for a package including the article and at least one coupon.

According to another aspect of the present invention the buyer that obtains the coupon from the ad-hoc multi-level marketing system 70 should transfer the coupon to another buyer for the coupon to be redeemed.

According to another aspect of the present invention the buyer that redeems the coupon at the ad-hoc multi-level marketing system 70 does not collect any price reduction for the redeemed coupon.

According to another aspect of the present invention the buyer that redeems the coupon at the ad-hoc multi-level marketing system 70 actually pays more for the article bought, or for the package including the article bought, which typically also contains at least one coupon.

According to another aspect of the present invention the coupon redeemed at the ad-hoc multi-level marketing system 70 by a buyer entitles the refund value associated with the coupon to the person who provided the coupon to the buyer, rather then to the buyer redeeming the coupon.

According to another aspect of the present invention the ad-hoc multi-level marketing method is a three-way process including the ad-hoc multi-level marketing system 70 and two buyers. The first buyer pays for the coupon when buying a first article at the ad-hoc multi-level marketing system 70, or for a package including an article and a coupon, and receives the refund value for the coupon if or when the coupon is redeemed. The second buyer receives the coupon from the first buyer and redeems the coupon by buying a second article at the ad-hoc multi-level marketing system 70, with and/or without another coupon.

According to another aspect of the present invention the ad-hoc multi-level marketing system 70 provides a coupon to a first buyer, receives the coupon from a second buyer, sells an article (with or without an additional coupon) to the buyer presenting the coupon, and refunds the first buyer the refund value of the first coupon.

According to another aspect of the present invention the ad-hoc multi-level marketing system 70 pays a first buyer at least part of the price collected from a second buyer for buying an article with a coupon.

According to another aspect of the present invention the ad-hoc multi-level marketing system 70 pays a first buyer obtaining a first coupon at least part of the price collected from a second buyer presenting the first coupon when the second buyer buys an article with a second coupon.

According to another aspect of the present invention the ad-hoc multi-level marketing system 70 enables a supplier and/or a seller to initiate a multi-level marketing operation where each user buying an article with a plurality of coupons introduces the system's offering to a plurality of potential buyers, thus increasing the circle of buyers with each generation.

According to another aspect of the present invention the ad-hoc multi-level marketing system 70 enables a supplier and/or a seller to initiate a multi-level marketing operation for a new type of article, implementing any of the above aspects.

According to another aspect of the present invention the ad-hoc multi-level marketing system 70 enables concurrent operation of the ad-hoc multi-level marketing method described above, implementing any of the above aspects, where different articles are offered by different suppliers and sellers to different buyers.

It is appreciated that various aspects of the administration of distribution system 11 and/ or ad-hoc multi-level marketing system 70 can be executed using a computer terminal or a workstation co-located with the respective server, such as system 11 or server computing device 71. Alternatively and preferably, at least some of the administration activities can be executed by remote users, using remote computer terminals or workstations, communicating with the respective servers (e.g. system 11 or server computing device 71) over a public communication network such as the Internet.

Particularly, such remote administration activities, may be executed by a remote campaign administrator of a supplier, for example, by setting a campaign, preferably using setup module 34 of software program 59, or any of steps 96-105 of ad-hoc multi-level marketing process 95.

It is expected that during the life of this patent many relevant methods and systems will be developed and the scope of the terms herein, particularly of the terms “data processing system”, “computational device”, “communication network”, “communication technology”, “articles” and “coupons” are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub -combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-22. (canceled)

23. A method for promoting sale, the method comprising the steps of:
providing a database of user records and a database of entitlement records;
a) enabling a user to perform the steps of:
i) registering in said database of users;
ii) receiving an entitlement for a coupon; and
iii) sending said entitlement for a coupon to another user;
wherein said entitlement has a record in said database of entitlement records, said entitlement record associating at least one of said entitlement and said coupon with a registration record of said user sending said entitlement; and
wherein a plurality of users perform steps i, ii and iii to create a database of a plurality of user records and a database of a plurality of entitlement records, wherein said entitlement records record a plurality of chains of entitlements associated with their sending user;
b) upon a purchase of said article using a coupon, using said database of entitlements and said database of users, perform the steps of:
identifying a chain of entitlements leading to said coupon used to purchase said article;
identifying a plurality of sending users associated with said chain of entitlements; and
distributing a commission associated with said coupon between said plurality of users.

24. The method of claim 23 additionally comprising identification means, wherein at least one of said coupon and said entitlement to a coupon comprises at least one of:
means for uniquely identifying at least one of said coupon and said entitlement; and
means for uniquely identifying at least one of said sending user and said receiving user.

25. The method of claim 23 wherein said plurality of users comprises a chain of users providing entitlements.

26. The method according to claim 25, additionally comprising a step of using said identification means for identifying at least one of:
said users comprising said chain of users;
order of said users comprising said chain of users; and
position of a user in said chain of users.

27. The method of claim 25 wherein said commission is distributed among said plurality of users according to the user's position in said chain.

28. The method of claim 23 wherein said sending user comprises a sequence of users providing entitlements from one user to another, and, upon a purchase of said article by said second user using said coupon, distributing said commission to users of said sequence of users according to said user's position in said sequence of users.

29. The method according to claim 23 wherein said sending users comprise a tree of users providing entitlements from one user to another starting with a root user and branching thereof, said method additionally comprising the steps of:
using said identification means for identifying a chain of users leading from said second user to said root user; and,
distributing said commission to users of said chain of users according to said user's position in said chain.

30. The method according to claim 23 wherein said sending users comprise a tree of users providing entitlements from one user to another said method additionally comprising the steps of:
registering a user receiving an entitlement as a subordinate of a user sending said entitlement;
identifying a chain of subordinates leading to said second user; and
distributing said commission to users of said chain of users according to said user's position in said chain.

31. A system for promoting sales of an article the system comprising:
a) a first computer comprising a database of users and a database of entitlements;
b) a user communication module communicatively coupled to a second computer, said user communication module enabling a first user to:
i) receive an entitlement to a first coupon, wherein said coupon bears a commission for sale of said article;
ii) using said entitlement, register as a coupon sender in said database of users; and
iii) using said entitlement, send to a second user, an entitlement to a second coupon, said entitlement being registered in said database of entitlements, wherein said entitlement associates between said first user as a sending user of said second coupon and said second user as a receiver of said second coupon;
c) a commission distribution module operative to perform, using said database of entitlements said database of users, upon a purchase of said article using any of said coupons, the steps of:
identifying a chain of entitlement leading to said coupon used to purchase said article;
identifying a plurality of sending users associated with said chain of entitlements; and
distributing said commission between said plurality of users.

32. The system according to claim 31 wherein said entitlement has a record in said database of entitlement records, said entitlement record associating at least one of said entitlement and said coupon with a registration record of said user sending said entitlement.

33. The system according to claim 31 wherein a plurality of users perform steps i, ii and iii to create a database of a plurality of user records and a database of a plurality of entitlement records, wherein said entitlement records record a plurality of chains of entitlements associated with their sending user.

34. The system according to claim 31 wherein said commission distribution module is additionally operative to perform at least one of the steps of:
distributing said commission between said plurality of users said users comprising said chain of users according to their order in said chain of users; and
distributing said commission between said plurality of users said users comprising said chain of users according to their respective position in said chain of users.
